(19) United States
(12) Patent Application Publication
(10) Pub. No.: US 2005/0108964 A1
(43) Pub. Date: May 26, 2005

(54) Panel element

(76) Inventor: Dieter Brinkkotter, Halle (DE)

Correspondence Address: Samuels, Gauthier & Stevens LLP, Suite 3300, 225 Franklin Street, Boston, MA, 02110, US

(21) Appl. No.: 10/695,437

(22) Filed: Oct. 28, 2003

(30) Foreign Application Priority Data
Oct. 30, 2002 (DE) 10250786.4

(51) Int. Cl. E06B 3/70

(52) U.S. Cl. 52/455; 52/578

(57) ABSTRACT

A panel element for garage doors, sectional doors, floor coverings, walls and the like, is fabricated from an extrudable material which is machinable after extrusion. At least the center region of the panel element is in the form of a hollow section and has multiple hollow inner chambers. The opposite longitudinal sides in each edge region of the panel element are in the form of a profitable solid section. The panel element is inexpensive to fabricate, especially when a large component of natural materials is provided in the extrudable material. Due to its design as a solid section in the edge regions, the panel element is capable of being profiled in such regions, for example, in order to provide a tongue-and groove-joint to interconnect multiple panel elements.

### BACKGROUND OF THE INVENTION

1. Field of the Invention

The invention relates to a panel element, specifically, for garage doors, composed of an extrudable material which is machinable after extrusion, with at least the center region of the panel element being in the form of a hollow section and having multiple hollow inner chambers.

2. Description of the Prior Art

Panel elements already exist which are in the form of double-walled structural elements for use in garage doors and made of multiple individual components creating an essentially cuboid shape, and which have seals along each longitudinal side allowing multiple panel elements to be mounted pivotably relative to each other, and which form one continuous unit for such a door when positioned in parallel alignment. Although the double-walled design does provide a certain level of insulation, panel elements of this type are complex in terms of design and expensive to fabricate.

The objective of the invention is therefore to create a panel element, specifically for sectional doors and garage doors, which is of a simple design composed of a small number of components and is inexpensive to fabricate.

### SUMMARY OF THE INVENTION

According to the invention, the panel element is composed of an extrudable material, the center region of the panel element being in the form of a hollow section, and the opposite longitudinal sides in one edge region of the panel element being in the form of a profitable solid section. Due to the hollow section design, the panel element inherently provides good thermal and sound insulation and may be fabricated as a single integral component. However, in an edge region at its longitudinal sides, the panel element may be in the form of a solid section, thereby allowing it to be profiled in this region, for example, to form a tongue-and-groove joint so that multiple panel elements may be combined to create a rolling door, wall covering, floor covering, or similar applications. In place of the tongue-and-groove joint, other attachment means may be installed in this region of the solid section; for example, screw connections may be provided in this region. The edge region in the form of a solid section may have either a rectangular cross-sectional shape which allows this region to be altered to any desired contour required by machining, or it may also have the profiled design created by the extrusion process.

According to a preferred embodiment of the invention, the panel element is fabricated from a mixture of natural materials such as wood fibers, wood chips, straw, hay, rice hulls, or the like, and polypropylene. These natural materials are extremely inexpensive to obtain and may be processed in a mixture containing a polymer, preferably, polypropylene, as part of the extrusion process. The heated mixture is forced through an extruder and may be immediately shaped into a panel element in the form of a hollow section. Dye additives may be used here to provide the desired color. The polypropylene component is preferably between 20% and 40% of the mixture, depending on the strength requirements. The mixture may also contain a cement component to achieve a stronger bond.

The edge region of the panel element in the form of a solid section is preferably between 1 cm and 10 cm, especially 3 cm and 7 cm across. This width allows for longer profiles for a tongue-and-groove joint and for sufficient strength in the edge region. The remaining center region of the panel element has hollow inner chambers, the cross-section of which preferably are essentially rectangular channels. As a result, relatively little material is required, and the weight of the panel element may be kept low, while the panel element retains a high degree of strength.

To the extent possible, the thickness of the exterior walls of the panel element ranges between 0.2 cm and 3 cm, preferably, 0.5 cm and 1 cm, so as to allow the outer walls to be provided with grooves or profiles. Particularly in such cases when the panel element is to be employed as a component of a sectional door, profiles and patterns of this type are desirable to provide the sectional door with an appropriate external appearance. For this reason, the wall thickness should allow for a certain degree of profiling.

The panel element may be provided as a cuboid structural component which may subsequently be profiled or coated. This allows a large quantity of panel elements to be inexpensively fabricated which may then be adapted for different products. Alternatively, it is also possible to provide the panel element immediately with profiled edge regions and/or a color coating immediately after extrusion.

These and other features, objectives and advantages of the present invention will now be described in greater detail with reference to the accompanying drawings, wherein:

### BRIEF DESCRIPTION OF THE DRAWINGS

FIG. 1 is a cross-sectional view of the panel element according to an embodiment of the invention;

FIG. 2 is a schematic view of the panel elements of FIG. 1 after installation and

FIG. 3 is a cross-sectional view of a panel element in another embodiment.

### DETAILED DESCRIPTION OF PREFERRED EMBODIMENTS

A panel element 1 is fabricated from an extrudable material consisting of a mixture of natural materials, specifically, wood fibers and wood chips together with polypropylene. The panel element is essentially of a cuboid form and has a first outer wall 2 and a second outer wall 3 on the side opposite the first. In the center region of panel element 1, which occupies 60% of the total volume, panel element 1 is in the form of a hollow section including hollow inner chambers 4. To enhance strength, ribs 5 are provided between the inner chambers, which ribs link outer walls 2 and 3.

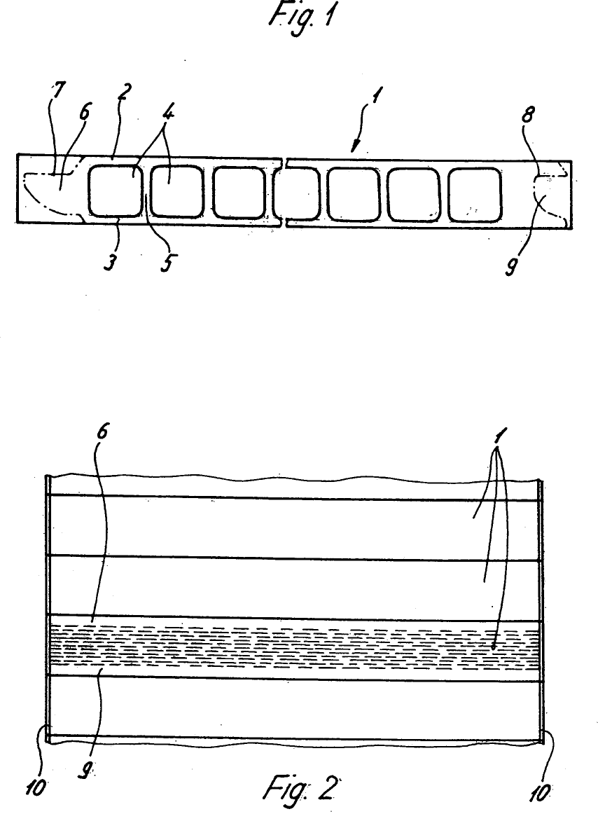

Edge regions 6 and 9 are provided in the form of solid sections at the opposite longitudinal sides of panel element 1. These edge regions 6 and 9 may be thus be used for mechanical attachment means, or for profiling purposes. In FIG. 1, a tongue profile 7, shown as a broken line, is provided in edge region 6, and a groove profile 8, shown as a broken line, is provided in edge region 9, which profiles are able to pivot or move within each other.

Tongue profile 7 and groove profile 8 may either be fabricated immediately by the extrusion process, or the panel element may be fabricated in an essentially cuboid shape and the profiling effected by machining, thus enabling a plurality of differently shaped panel elements to be fabricated from standardized panel element 1.

FIG. 2 shows a possible application for panel element 1 in a garage door or sectional door. Panel elements 1 are interlinked at their longitudinal sides, and their edge regions are provided with coverings 10. Coverings 10 enclose the inner chambers 4 of panel element 1. Coverings 10 are interlinked in an articulated arrangement by hinge elements, not shown, thereby allowing the unit composed of multiple panel elements 1 to be moved along a curved track in the known manner for garage doors or sectional doors.

To enhance thermal and sound insulation properties, it is possible to insert insulating material into inner chambers 4.

In addition, it is possible to provide outer walls 2 and 3 with a certain profile, for example, ribbing to create an antiskid surface, grooving, or an engraved motif. Furthermore, a color coating may be applied to outer walls 2 and 3.

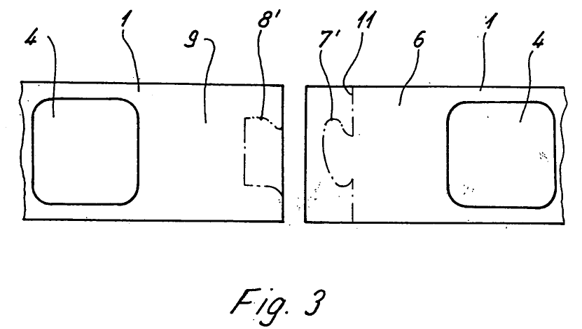

The embodiment of panel element 1 shown in FIG. 3 is of essentially the same design as in FIG. 1—however, panel element 1 may be employed either as a floor covering or as a wall element. A tongue 7′ is provided on one longitudinal side of panel element 1, which tongue projects in a mushroom-head shape from front edge 11. An undercut groove 8′ is formed on an opposite longitudinal side of another panel element 1, which groove has a downward facing projection, and which tongue 7′ is essentially able to engage in a form-locking manner. This design allows for mechanical locking of the two panel elements 1 which are also unlockable, for example, in order to produce a mobile floor covering, as is described in patent application DE 101 58 730. Groove 8′ and tongue 7′ are integrated into panel element 1; although it is of course also possible to provide groove 8′ and tongue 7′ as metal sections which are extruded into the material.

Instead of providing mechanical locking, it is of course also possible to profile panel elements 1 using other forms of grooves or tongues which may then be glued together. In place of grooves and tongues, alternating folded seam joints may be produced which then allow the edge regions of adjacent longitudinal sides to overlap.

1. A panel element for garage doors, sectional doors, floor coverings, walls and the like, said panel element being extruded from a material which is machinable after extrusion, at least the center region of the panel element being in the form of a hollow section and having multiple hollow inner chambers, with opposite longitudinal sides in edge regions of the panel element being in the form of profitable solid sections.

2. The panel element according to claim 1, wherein the panel element is fabricated from a mixture of natural materials, such as wood fibers, wood chips, straw, hay, rice hulls, or the like, and polypropylene.

3. The panel element according to claim 2, wherein the polypropylene component may range between 20% and 40% of said mixture.

4. The panel element according to claims 2 or 3, wherein one component of said mixture is cement.

5. The panel element according to any one of claims 1 to 3 wherein said edge regions are in the form of solid sections between 1 cm and 10 cm wide.

6. The panel element according to any one of claims 1 to 3 wherein said hollow inner chambers are in the form of channels having substantially rectangular cross-sections.

7. The panel element according to any one of claims 1 to 3 wherein said inner chambers are located between outer walls having thicknesses of 0.2 and 3.0 cm.

8. The panel element according to any one of claims 1 to 3 wherein a groove profile is provided at a first longitudinal side, and a tongue profile is provided at a second longitudinal side.

9. The panel element according to any one of claims 1 to 3 wherein outer surfaces of said panel element are provided with a color coating.

10. The panel element according to any one of claims 1 to 3 wherein said inner chambers are filled with an insulating material.
